(19) United States
(12) Patent Application Publication
(10) Pub. No.: US 2015/0212016 A1
(43) Pub. Date: Jul. 30, 2015

(54) Sample Plate for An X-Ray Powder Diffraction Apparatus

(71) Applicant: Glaxo Group Limited, Brentford (GB)

(72) Inventors: Glenn WILLIAMS, Collegeville, PA (US); Feirong KANG, King of Prussia, PA (US)

(21) Appl. No.: 14/682,201

(22) Filed: Apr. 9, 2015

Related U.S. Application Data
(63) Continuation of application No. 13/504,564, filed on May 16, 2012.
(60) Provisional application No. 61/255,883, filed on Oct. 29, 2009.

(51) Int. Cl. G01N 23/20; G01N 23/207

(52) U.S. Cl. CPC G01N 23/20025; G01N 23/207

(57) ABSTRACT

A sample plate for use in an X-ray powder diffraction apparatus, the sample plate comprising a body having an exterior circumference which rotatable about a central axis, and a self contained rotating mechanism for rotating a sample holder containing a powder about a longitudinal axis, wherein the longitudinal axis intersects central axis; and wherein rotation about the central axis and rotation about the longitudinal axis occur simultaneously.

### FIELD OF THE INVENTION

The present invention relates to the field characterizing powdered materials using X-ray powder diffraction. More specifically, the invention relates to a sample plate for use in an X-ray diffraction apparatus, and method collecting X-ray powder diffraction data using such a sample plate.

### BACKGROUND OF THE INVENTION

X-ray powder diffraction (XRPD) is a useful method in identifying different crystalline phases by their unique X-ray diffraction patterns. XRPD patterns provide data to determine the crystalline structure and phase composition of crystalline samples, yet morphology and particle shape/size can induce preferential orientation which can degrade the interpretation of the data. Small changes in the X-ray powder patterns, such as appearance of new peaks, additional shoulders or shifts in the peak position, can imply the presence of a new polymorph.

Preferred orientation is a well-known phenomenon and has the potential to be misguiding. This is due to difficulties that arise from artifacts of the analytical process employed, rather than from the polymorphism of the sample being characterized. Analytical artifacts may be the result of changes in powder X-ray diffraction patterns due to particle size and morphology or sample holder geometry. To lessen artifact impact on the overall characterization, corrective measures are typically employed, such as grinding the sample and/or using software correction. In some cases, however, artifacts can only be eliminated through the use of a rotating sample holder. The XRPD devices using this approach generally use a first sample holder fitting to rotate the sample plate containing the sample around the central axis of the sample plate. A separate secondary analytical step is then employed, which uses a separate sample holder fitting to rotate the sample about its longitudinal access. Devices for holding samples within a capillary in an X-ray powder diffraction, for example, as described in U.S. Pat. No. 4,641,329. These separate readings are then analyzed with corrective software to filter through analytical artifacts to arrive at a characterization, post-data manipulation. Other hardware and software methods also exist to address preferred orientation effect in XRPD.

The existing commercial technologies for multi-dimensional XRPD analysis remain complex. Some devices, as described above, collect data using multiple sample rotation jigs. The XRPD equipment must be stopped, partially disassembled and reassembled with the appropriate jig, and then testing on given axes can be commenced. The device must then be stopped, the first jig removed, another jig set up put in place, and data collected from the second jig. The present invention seeks to address the inefficiencies in employing such an approach.

In other instances, specialized post-data collection computer assisted correction must be employed. The present invention however seeks to collect data with reduced preferred orientation artifacts, thus reducing the need to rely on post experimental correction, or which yield more accurate information when such post corrective software is employed.

### SUMMARY OF THE INVENTION

The current invention is meant to overcome the shortcomings of the existing technology. The invention is directed to an X-ray powder diffraction apparatus sample plate having a self contained rotator for rotating a sample holder axially around a longitudinal axis, while the sample plate is simultaneously rotatable about its central axis.

In one aspect, the present invention is directed to a sample plate for use in an X-ray powder diffraction apparatus. The sample plate would comprise a body having a central axis and an exterior circumference spaced from the central axis, a sample holder defining a cavity for containing a powder sample, the sample holder having a longitudinal axis, where the sample holder is positioned within the body intersecting the central axis, and a self contained rotator for rotating the sample holder axially around the longitudinal axis.

### BRIEF DESCRIPTION OF THE FIGURES

FIG. 1 is a top perspective view of one embodiment of the sample plate containing a sample holder.

FIG. 2 is a cross sectional view of the drive wheel.

FIG. 3 is a cross sectional view of a sample holder, containing a sample material.

FIG. 4 is perspective view of the sample plate of the present invention, showing central axis (A), about which the sample plate is rotatable, and longitudinal axis (B), about which the sample holder is rotatable.

FIG. 5 is representative X-ray powder diffraction data with circumferential rotation of the sample plate.

FIG. 6 is representative X-ray powder diffraction data with circumferential rotation of the sample plate and simultaneous axial rotation of the sample holder about the holder's longitudinal axis.

### DETAILED DESCRIPTION OF THE INVENTION

As discussed in detail below, the X-ray powder diffraction powder analysis apparatus of the invention includes at least sample plate for use in an X-ray powder diffraction apparatus, a body having a central axis and an exterior circumference spaced from said central axis, a sample holder and a self contained rotator for rotating the sample holder axially around the longitudinal axis. It is to be understood that a sample plate is not limiting and can refer to any geometric shape that is capable of performing the same function as the sample plate.

Reference will now be made in detail to presently preferred embodiments of the invention, one or more examples of which are illustrated in the accompanying figures. As indicated above, repeat use of reference characters herein and in the figures is intended to represent same or analogous features or elements of the invention.

Before describing the present invention in detail, it is to be understood that this invention is not limited to particularly exemplified materials, methods or structures as such may, of course, vary. Thus, although a number of materials and methods similar or equivalent to those described herein can be used in the practice of the present invention, the preferred materials and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains. Further, all publications, patents and patent applications cited herein, whether supra or infra, are hereby incorporated by reference in their entirety.

Finally, as used in this specification and the appended claims, the singular forms “a”, “an” and “the” include plural referents unless the content clearly dictates otherwise.

Reference will now be made in detail to presently preferred embodiments of the invention, one or more examples of which are illustrated in the accompanying figures. As indicated above, repeat use of reference characters herein and in the figures is intended to represent same or analogous features or elements of the invention.

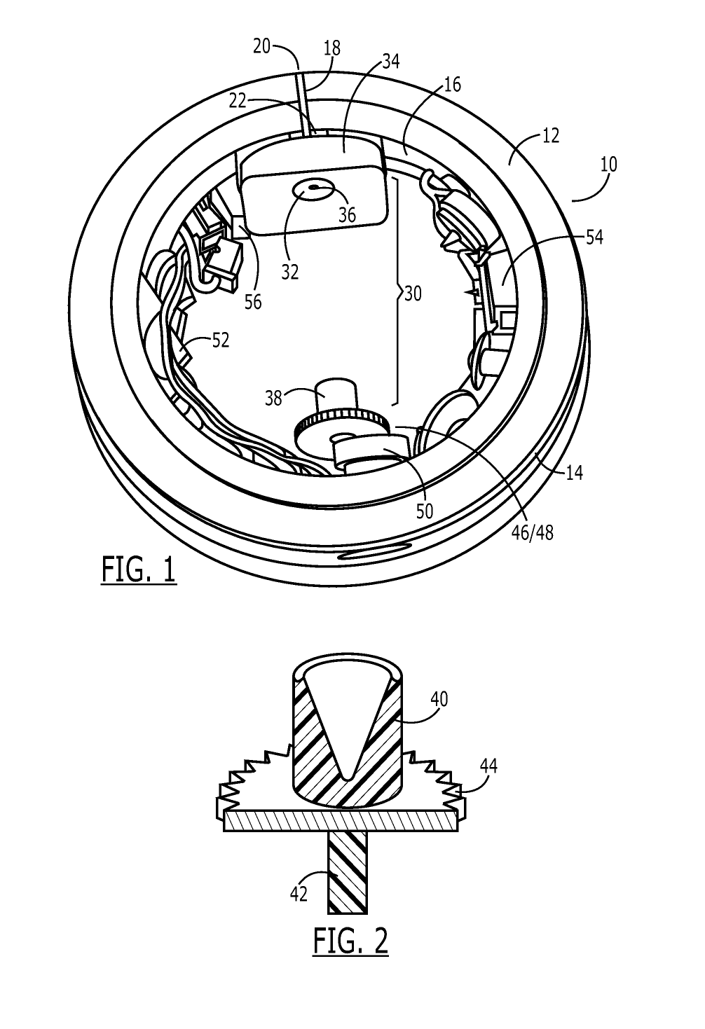

FIGS. 1 to 4 depict an embodiment of an X-ray diffraction sample plate (10) of the present invention. The sample plate has three major components, a ring-shaped body (10), a sample holder (60) and sample holder rotator mechanism (30).

Ring-shaped body (12) has an exterior circumference (14), an inner annular surface (16), through which extends a sample holder loading channel (18). The sample holder loading channel has an outer opening (20) and an inner opening (22). The body (12) is equipped with a self-contained sample holder rotating mechanism (30). The rotating mechanism (30), in the embodiment depicted, possesses a free wheel (32) rotatably positioned in a free wheel bracket (34). The free wheel defines a wheel channel (36) which extends through the free wheel (32), with the wheel channel (36) being coextensive with the sample holder loading channel (18). The guide wheel has an inner face that is positioned such that it faces a drive wheel (38), located on the opposite the side of the interior annular surface of body (10). The drive wheel (38) possesses a receiver cup (40), an axle (42) and a toothed wheel (44). Toothed wheel (44) engages a corresponding toothed rotor wheel (46) mounted on the drive shaft (48) of a motor (50) mounted to the interior surface of body (10). Motor (50) is connected by a series of wires (52) to a powder source (54), such as batteries, and is operable by a switch (56).

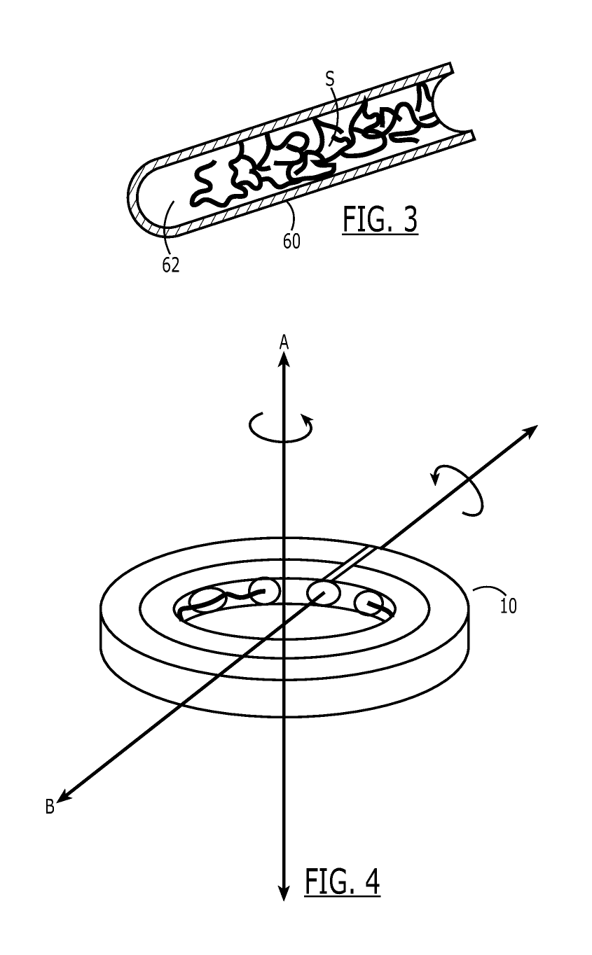

A sample holder (60), for example a tubular capillary with a central sample containing bore or cavity (62) is depicted in FIG. 3, in which is loaded a sample (S) of solid, semi-solid, suspension, or liquid materials.

As depicted in FIG. 4, bore (62) of sample holder (60), is filled with a sample material (S), and the filled sample holder (60) is positioned into the sample plate. Standard capillary sample holders may be employed in this regard, for example a 10-QZ (Quartz) 1.0 mm capillary from Charles Supper Company, Natick, Mass. USA. This is done by inserting the sample holder into the outer opening (20) of the sample holder loading channel (18), and through the wheel channel (36) of the free wheel (32). The sample holder is slid into the received cup (40) and insertion is complete when the end of the sample holder abuts the sides or bottom of the cup and is thus snuggly engaged. While the interior of the cup may be configured in any suitable manner, such as cylindrical, advantageously a frustoconical interior surface is employed with good success. The sample holder opposite the receiving cup is maintained by a suitable closure, clip, bonding material, etc. For example, a rubber or clay may be employed to retain the sample holder in wheel channel (36).

In use, sample plate is rotatable about a central axis (A). The rotation of sample plate (10) around axis A has been represented by the rotation arrow on axis A in FIG. 4. Rotation of the sample holder (60), being facilitated the drive and free wheels (38 and 32), is about a longitudinal axis of the sample holder, depicted as axis (B) generally depicted by arrows on the axis (B). The depicted directions of these arrows are merely for purposes of illustration, and it will be understood that the sample plate and sample holder may be respectively rotated in either direction without departing from the scope of the invention.

The sample holder is thus structured so that the longitudinal axis of the sample holder intersects the central axis of the sample plate, such that it is possible to expose the sample holder to an X-ray beam through this area of intersection, and have the sample (S) be rotated simultaneously about both axis A and axis B.

An example of a sample plate would be a model 9430 018 18401 Transmission Holders (3×) available from PANalytical EMEA, Twentepoort Oost 26, 7609 RG Almelo, The Netherlands.

A number of types of motors (50) could be used to provide the rotation and would include electric, pneumatic, hydraulic and combinations thereof. In alternative embodiments, the drive shaft (48) of motor (50) may be directly linked receiver cup (40), thus eliminating the various intermediate gearing (44 and 46). In still further embodiments, the rotating mechanism could employ geared couplings, hydraulic couplings, magnetic couplings and/or combinations thereof.

An example of a motor (50) usable as the rotating mechanism (30) is a DiDel SA MK series motor (CH-1092 Belmont, Switzerland). As will be appreciated by one having ordinary skill in the art, conventional gearing may be employed, for example in on the toothed wheel (44) and toothed rotor wheel (46) used in the rotator mechanism (30). An example of the type of gearing that could be used would be a DiDel SA 4R5 gear set.

An example of a power source (54) capable of powering the motor (50) is a Rayovak #13 zinc 1.4v hearing aid battery. One or more batteries may be employed as the power source, and are positionable on the inner annular surface (16) of the sample plate body (12).

An example of a switch (56) capable of regulating a circuit between the motor (50) of the rotating mechanism (30) would be a C-K Components (Newton, Mass.) switch, model GS04MCBE. A further embodiment would use multiple switches.

So configured, the sample plate of the present invention allows a sample to be rotated simultaneously about the central axis A (X-Y rotation) and about the longitudinal axis (B axis) (Z-rotation). Further, the sample plate provides a simple self contained mechanism for allowing multi-dimensional rotation of the sample. Advantageously, the sample holder rotating mechanism is operable independent of the XRPD station, such that an XRPD device that is in a standard configuration for sample plate rotation alone can operate in this simultaneous axial rotation manner without the need to modify the XRPD analytical device. The XRPD device can thus collect multi-axial data without the need to change sample holding jigs. Further, because the longitudinal axis rotation mechanism is contained in/on the sample plate itself, there is no need to modify the commercially sold XRPD device's sample plate holder jig to facilitate longitudinal rotation.

Furthermore, sample plates configured according to this invention may be serially loaded by a programmable robotic plate loading arm into existing commercially sold XRPD apparatuses. Once the arm and XRPD device is programmed, the plates with powder-loaded sample holders could be automatically fed into the XRPD device. Once a given plate is placed by the arm into the XRPD testing device, with its sample holder longitudinal axis rotation mechanism activated, the multi-dimensional XRPD analysis may be done. When completed, the arm would remove the tested plate, and load the next sample plate. In this manner, a number of plates may be tested.

Thus benefits include reducing preferred orientation readings in real time (rather than post-collection software based correction), avoiding having to switch jigs to make multi-axial analyses, avoiding modification of sample plate holders on commercially available XRPD devices, and reducing the need for a technician to operate XRPD devices.

The invention is also related to a method of reducing preferred orientation in X-ray diffraction patterns, where the method comprises, providing a sample plate as described herein in an X-ray diffraction apparatus that emits an X-ray beam. The sample plate has body and a central axis (A) around which the plate can rotate. In performing an X-ray powder diffraction measurement the following steps may be taken:
loading a powder sample into a sample holder defining a cavity for containing the powder sample;
positioning the powder loaded sample holder containing a powder sample within the sample plate, such that the longitudinal axis of sample holder intersects the central axis of the sample plate;
rotating the sample holder axially around the longitudinal axis, while simultaneously rotating the sample plate about the central axis;
exposing the sample holder to an X-ray beam; and
collecting X-ray diffraction data while the sample plate and sample holder are being simultaneously rotated around the central axis and longitudinal axis respectively.

### EXPERIMENTAL DATA

The following examples are given to enable those skilled in the art to more clearly understand and practice the present invention. They should not be considered as limiting the scope of the invention, but merely as being illustrated as representative thereof.

### Example 1

### X-Ray Diffraction Data Collected with Sample Plate Rotation

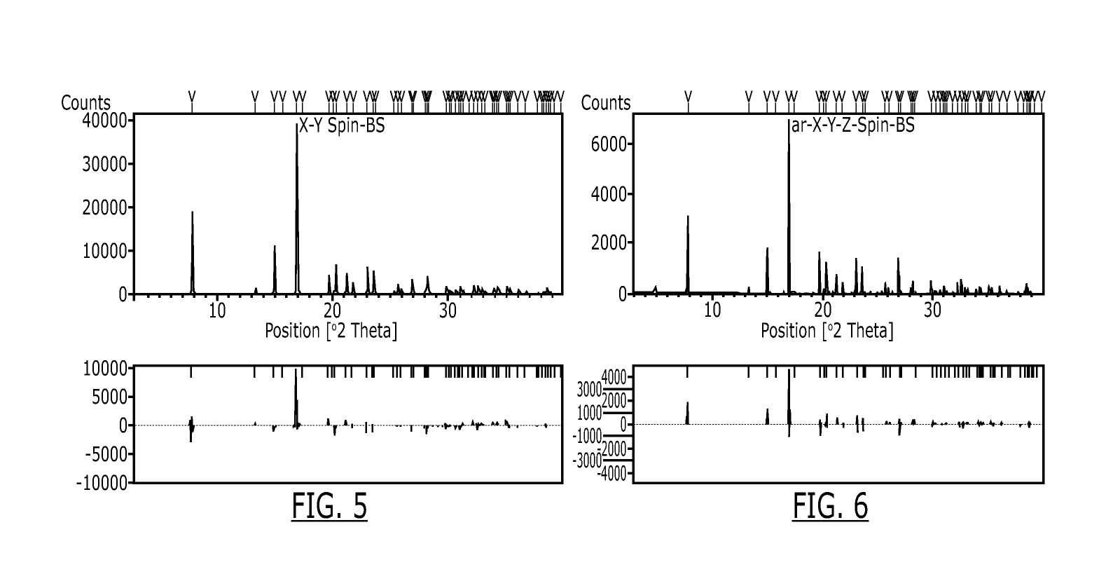

FIG. 5 is exemplary of the data collected. The data was collected using the conditions listed below:

Sample Mode: Transmission

Scan range: 3-40 degrees two-theta

Generator power: 40 kV, 40 mA

Radiation Source: Cu Ka

Scan type: Continuous

Time per step: 30 seconds

Step size: 0.0167 degrees two-theta per step

Sample Rotation: None

Incident Beam optics: Mirror Optics—Inc. Beam Cu w/Si (focusing MPD),

0.02 radian soller slits, ½ degree fixed divergence slit

Diffracted Beam optics: 0.0625 degree prog. anti-scatter slit assembly

(X'celerator module), 0.02 radian soller slits

Detector Type: Philips X'Celerator RTMS (Real Time Multi Strip)

The upper portion of FIG. 5 depicts both the calculated pattern from single crystal structure and the transmission analysis. The lower portion of FIG. 5 depicts the difference in counts between the calculated and actual diffraction pattern.

### Example 2

### X-Ray Diffraction Data Collected with Both Sample Plate and Sample Holder Axial Rotation

FIG. 6 is exemplary of the data collected with sample plate (10) rotation (Axis A) and sample holder (60) longitudinal axis rotation (Axis B). The data was collected using the conditions listed below:

Sample Mode: Transmission

Scan range: 3-40 degrees two-theta

Generator power: 40 kV, 40 mA

Radiation Source: Cu Ka

Scan type: Continuous

Time per step: 30 seconds

Step size: 0.0167 degrees two-theta per step

Sample Rotation: 0.5 s revolution time

Incident Beam optics: Mirror Optics—Inc. Beam Cu w/Si (focusing MPD),

0.02 radian soller slits, ½ degree fixed divergence slit

Diffracted Beam optics: 0.0625 degree prog. anti-scatter slit assembly

(X'celerator module), 0.02 radian soller slits

Detector Type: Philips X'Celerator RIMS (Real Time Multi Strip)

The upper portion of FIG. 6 depicts both the calculated pattern from single crystal structure and the transmission analysis. The lower portion of FIG. 6 depicts the difference in counts between the calculated and actual diffraction pattern.

Without departing from the spirit and scope of this invention, one having ordinary skill in the art can make various changes and modifications to the invention to adapt it to various usages and conditions. As such, these changes and modifications are properly, equitably, and intended to be, within the full range of equivalence of the following claims.

What is claimed is:

1. A sample plate for use in an X-ray powder diffraction apparatus, said sample plate comprising:
a body having an exterior circumference which rotatable about a central axis, and a self contained rotating mechanism for rotating a sample holder containing a powder about a longitudinal axis,
wherein the longitudinal axis intersects central axis; and
wherein rotation about the central axis and rotation about the longitudinal axis occur simultaneously.

2. The sample plate of claim 1, wherein said self contained rotator comprises a motor located on said body.

3. The sample plate of claim 2, wherein said motor is actively coupled to said sample holder by one or more gears.

4. The sample plate of claim 2, wherein said motor is an electric motor.

5. The sample plate of claim 4, further comprising one or more batteries positioned on said body, and being electronically connected to said electric motor.

6. The sample plate of claim 5, further comprising at least one switch for regulating a circuit between said motor and said one or more batteries.

7. A method of reducing preferred orientation in X-ray diffraction patterns comprising:
providing an X-ray diffraction apparatus which emits an x-ray beam;
providing a sample plate for use in said X-ray powder diffraction apparatus, said sample plate comprising
a body having a central axis and an exterior circumference spaced from said central axis;
a sample holder defining a cavity for containing a powder sample, said sample holder having a longitudinal axis, wherein said sample holder is positioned within the body intersecting the central axis, and;
a self contained rotator for rotating the sample holder axially around the longitudinal axis;
loading a powder sample into said sample holder;
loading said sample holder into said sample plate such that said sample holder intersects said central axis;
positioning said sample plate within an X-ray diffraction apparatus;
rotating said sample plate around said central axis while simultaneously rotating said sample holder around said longitudinal axis; and
exposing said sample holder to said x-ray beam at the point of intersection with said central axis; and
collecting the X-ray powder diffraction pattern of said sample.

9. The method of claim 8, wherein said self contained rotator is supplied by a motor.

10. The method of claim 8, wherein said self contained rotator is connected to said sample holder by a drive mechanism selected from the group consisting of a direct coupling, a geared coupling, a hydraulic coupling, a magnetic coupling and combinations thereof.

11. The method of claim 9, wherein said motor is electric.

12. The method of claim 11, wherein said electric motor is connected to a battery carried on said sample plate.

13. The method of claim 13, wherein said sample plate further comprises at least one switch operative connecting said battery and said motor.
